(19) United States
(12) Patent Application Publication
(10) Pub. No.: US 2011/0314831 A1
(43) Pub. Date: Dec. 29, 2011

(54) SECONDARY WATER INJECTION FOR DIFFUSION COMBUSTION SYSTEMS

(76) Inventors: Khalil F. Abou-Jaoude, Winter Springs, FL (US); Stephen E. Mumford, Longwood, FL (US)

(21) Appl. No.: 13/163,826

(22) Filed: Jun. 20, 2011

Related U.S. Application Data
(60) Provisional application No. 61/357,616, filed on Jun. 23, 2010.

(51) Int. Cl. F02C 7/22

(52) U.S. Cl. 60/772; 60/734

(57) ABSTRACT

Emissions and combustion dynamics of a turbine engine are managed through a combustor system that injects water into the primary fuel flow and supplies a secondary water steam to the flame zone of the combustor through a central, secondary liquid nozzle or of the fuel nozzle assembly.

### CROSS-REFERENCE TO RELATED APPLICATION

This application claims priority to U.S. provisional application No. 61/357,616, filed on Jun. 23, 2010, in its entirety.

### FIELD OF THE INVENTION

The invention generally relates to diffusion flame combustors for turbine engines and more particularly to supplying water in the form of liquid water to such diffusion flame combustors.

### BACKGROUND OF THE INVENTION

NOx is a generic term for the mono-nitrogen oxides NO and NO₂ (nitric oxide and nitrogen dioxide). Combustor development focuses on meeting exhaust NOx emissions without negatively impacting other critical areas that are part of the overall system design. With diffusion flame combustors, water or steam can be injected into the combustor to control NOx emissions. Injecting water can cause unwanted stability problems in the form of high combustor dynamics and durability issues with respect to liner cracking. The development of such systems requires a delicate balance of these competing design criteria—emissions, dynamics, and hardware life.

In diffusion flame combustors of gas turbine engines, a primary fuel is supplied, frequently in a gaseous state such as methane or natural gas. In the combustor, the fuel gas is mixed with compressed air and water in the form of liquid, vapor or steam. Design criteria requires proper mixing of the fuel and water. Ineffective methods for distributing and mixing the H2O result in greater NOx emissions and unacceptable dynamics.

Therefore, not only is it beneficial to reduce engine emissions, but it is also desirable to improve combustion dynamics and engine performance by enabling acceptable engine operation at higher flame temperatures; the present invention facilitates each of these goals.

### SUMMARY OF THE INVENTION

According to aspects of the invention, a turbine engine combustion system includes a fuel nozzle assembly having a primary fuel outlet and a secondary nozzle for spraying a liquid downstream of the primary fuel outlet into the flame zone of the combustor. A fuel line, in fluid communication with the primary fuel outlet, supplies fuel to the primary fuel outlet. A primary water line supplies water to mix with fuel upstream of the primary fuel outlet, and a secondary line provides water to the flame zone through the secondary liquid spray nozzle. The secondary nozzle is aligned on the centerline of the fuel nozzle assembly. The secondary liquid nozzle dispenses the water in a hollow cone spray pattern into the combustor.

A separate line can also supply a secondary fuel, such as a liquid oil fuel, to the secondary liquid nozzle. The primary fuel can be gaseous.

The fuel nozzle assembly can also include an atomizing air cap having a plurality of holes surrounding the liquid nozzle.

Aspects of the invention also present a method for controlling emissions in a turbine combustor comprising the steps of:
injecting primary water into a first fuel flow;
supplying the first fuel flow and water mixture to a combustion chamber through a fuel nozzle assembly,
combusting the first fuel flow in a flame zone; and
injecting secondary water into the flame zone in a hollow cone spray pattern.

These systems and methods improve the control of emissions while managing combustion dynamics and reducing wear on system hardware

### BRIEF DESCRIPTION OF THE DRAWINGS

FIG. 1 is a schematic view of a fuel nozzle assembly for a diffusion flame combustor with primary and secondary water supply lines.

FIG. 2 is a schematic right-hand end view of FIG. 1, showing an atomizing air cap and a liquid fuel nozzle.

### DETAILED DESCRIPTION OF EMBODIMENTS OF THE INVENTION

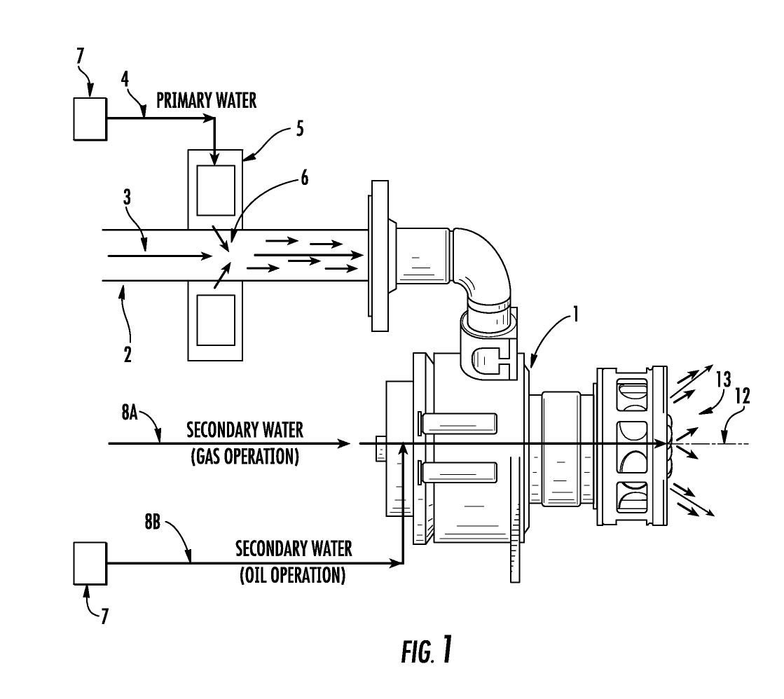

Referring to FIG. 1, a fuel nozzle assembly 1 for a turbine engine diffusion flame combustor is provided. A fuel line 2 can supply fuel 3 to the fuel nozzle assembly 1. A primary fluid (water) line 4 can supply a first fluid, such as water, to a water injection donut 5 coupled to the fuel line 2. The water injection donut 5 can be mounted so as to surround or to encircle the fuel line 2. The water injection donut 5 can facilitate injection of one or more water streams 6 into the fuel 3 flowing through the fuel line 2.

Additionally or alternatively, water is injected into the burning flame zone of the combustor downstream of the fuel nozzle assembly 1. Injecting water into both the fuel and combustion zone can control exhaust emissions, particularly NOx.

As used herein, water refers to its various phases, including liquid or vapor, and combinations of liquid and vapor, and including droplets. Water may be referred herein to alternatively as liquid, vapor or steam.

A secondary fluid (water) line 8 can also supply a second fluid 13, such as water, to the fuel nozzle assembly 1. The secondary water line 8 (8A, 8B) can be used alone or in combination with the primary water line 4. The primary water line 4 and the secondary water line 8 can be supplied by the same or different water sources 7. When the combustion turbine is operating on natural gas, it can be beneficial to inject water at two locations via the primary water line 4 and the secondary water line 8. When both the primary water line 4 and the secondary water line 8 are employed, the supply of water is typically split equally between the two injection sites, primary and secondary. Different supply ratios can be employed. For example, the ratio of water supply via the primary water line 4 to water supply via the secondary water line 8 can be 50:50, 60:40, 70:30, 80:20, 90:10, 100:0, 40:60, 30:70, 20:80, 10:90, or 0:100 or any other combination.

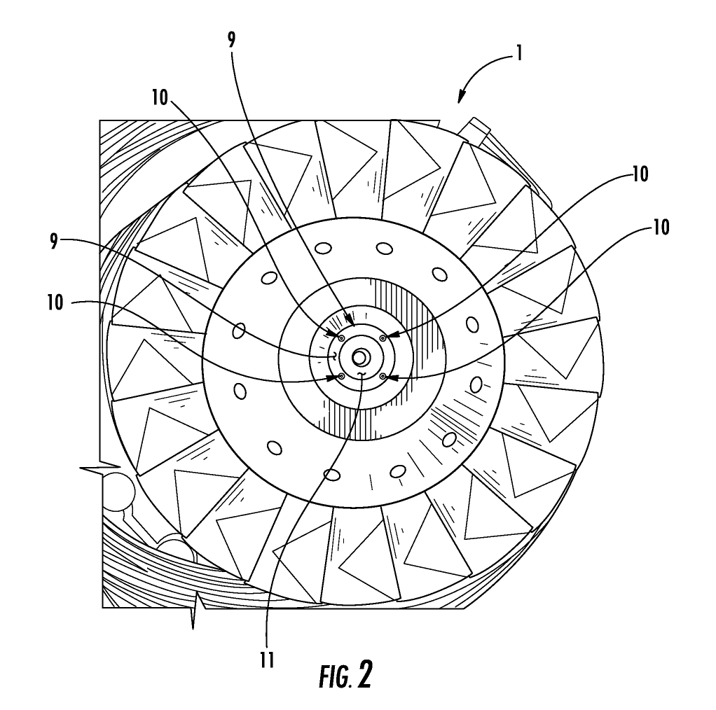

The secondary water line 8A can supply water to the combustor through the fuel nozzle assembly 1. Referring to FIG. 2, a liquid fuel nozzle 11, for example, on the fuel nozzle assembly can be used to inject water from the secondary fluid line 8A. The liquid fuel nozzle 11 can be aligned on the centerline 12 of the fuel nozzle assembly, as illustrated in FIG. 1. The centerline 12 can be parallel to a direction of flow through the fuel nozzle assembly 1. The liquid fuel nozzle 11 advantageously distributes the water equally about the centerline 12 in a hollow cone spray pattern. The quality of the water spray is improved by injection through the liquid fuel nozzle 11 as it creates a uniform distribution and small water droplets or particles. This pattern can result in improved mixing of the secondary water with the gaseous fuel for effective NOx reduction and improved stability. The flow rate of the liquid fuel nozzle 11 is preferably calibrated to about ±3%.

The fuel nozzle assembly 1 can include an atomizing air cap 9. The atomizing air cap 9 can surround the secondary injection liquid fuel nozzle 11 and have one or more holes 10. For example, the atomizing air cap 9 can have four holes 10. In prior gas fuel systems, water has been supplied through the holes 10, but the atomizing air cap 9 can suffer from poor water distribution caused by, for instance, the formation of large droplets resulting from injection via the discreet hole or holes 10. Further, since the orientation of the holes 10 is not controlled during hardware assembly, a variation among combustor positions for the engine can exist.

According to aspects of the invention, water is supplied through the secondary injection liquid fuel nozzle 11 rather than the holes 10 of the atomizing air cap 9 during gas fuel operation. This alternate water injection scheme to inject water into the combustor, operating on gaseous fuel, helps to reduce NOx emissions while maintaining acceptable dynamic activity. Tests have demonstrated that embodiments that inject water in a more controlled manner, via the liquid fuel nozzle 11, can benefit in all three design areas—emissions, dynamics, and hardware life. Prior to implementing this design, the engine had difficulty meeting desired emissions targets while at the same time maintaining acceptable dynamics. Therefore, it has been found to be beneficial to use the liquid fuel nozzle 11 to inject the secondary water into the flame zone instead of the atomizing air cap 9. The atomizing air cap is used to inject water during high load liquid fuel operation.

What is claimed is:

1. A turbine engine combustion system comprising:
a combustion chamber providing a flame zone for combusted fuel;
a fuel nozzle assembly having a primary fuel outlet and a secondary liquid nozzle for spraying a liquid downstream of the primary fuel outlet into the flame zone;
a fuel line in fluid communication with the primary fuel outlet for supplying fuel to the primary fuel outlet;
a primary water line in fluid communication with the fuel line and which supplies water to mix with fuel in the fuel line upstream of the primary fuel outlet; and
a secondary water line in fluid communication with the secondary liquid fuel nozzle for supplying water to the flame zone through the secondary liquid nozzle.

2. The system according to claim 1, wherein the secondary liquid nozzle is substantially aligned on a centerline of the fuel nozzle assembly.

3. The system according to claim 1, wherein the secondary liquid nozzle dispenses the water in a hollow cone spray pattern into the combustor.

4. The system according to claim 1, further comprising a secondary line for supplying either a secondary fuel or water to the secondary nozzle.

5. The system according to claim 1, wherein the secondary fuel is an oil fuel.

6. The system according to claim 1, wherein the fuel to the primary fuel outlet is gaseous.

7. The system according to claim 1, wherein the fuel nozzle assembly includes an atomizing air cap having a plurality of holes surrounding the second fuel nozzle.

8. The system according to claim 1, wherein the liquid nozzle is flow calibrated to about ±3%.

9. A fuel nozzle assembly for a turbine engine combustion system comprising:
a fuel nozzle assembly having a primary fuel outlet and a secondary liquid nozzle for spraying a liquid downstream of the primary fuel outlet;
a fuel line in fluid communication with the primary fuel outlet for supplying fuel to the primary fuel outlet;
a primary water line in fluid communication with the fuel line and which supplies water to mix with fuel in the fuel line upstream of the primary fuel outlet; and
a secondary water line in fluid communication with the secondary liquid nozzle for supplying either fuel or water through the secondary fuel nozzle.

10. The system according to claim 11, wherein the secondary liquid nozzle is substantially aligned on a centerline of the fuel nozzle assembly.

11. The system according to claim 11, wherein the nozzle dispenses the water in a hollow cone spray pattern during gas fuel operation.

12. The system according to claim 11, further comprising a secondary fuel line for supplying a secondary fuel to the secondary liquid nozzle.

13. The system according to claim 11, wherein the secondary fuel is an oil fuel.

14. The system according to claim 11, wherein the fuel to the primary fuel outlet is gaseous.

15. The system according to claim 11, wherein the fuel nozzle assembly includes an atomizing air cap having a plurality of holes surrounding the secondary liquid nozzle.

16. A method for controlling emissions in a turbine combustor comprising the steps of:
injecting water into a primary gaseous fuel flow;
supplying the first fuel flow injected with water to a combustion chamber through a fuel nozzle assembly,
combusting the first fuel flow in a flame zone; and
injecting water into the flame zone in a hollow cone spray pattern.
